(19) United States
(12) Patent Application Publication
(10) Pub. No.: US 2026/0188160 A1
(43) Pub. Date: Jul. 2, 2026

(54) DISPLAY DEVICE AND DISPLAY CONTROL METHOD

(71) Applicant: TCL CHINA STAR OPTOELECTRONICS TECHNOLOGY CO., LTD., Shenzhen (CN)

(72) Inventors: Weifeng CHEN, Shenzhen (CN); Kaiyu LIU, Shenzhen (CN); Qianqian LV, Shenzhen (CN); Fan CHEN, Shenzhen (CN); Xianli SHANG, Shenzhen (CN); Haiqi MO, Shenzhen (CN); Jianjiao WANG, Shenzhen (CN); Xiaoying GUO, Shenzhen (CN)

(73) Assignee: TCL CHINA STAR OPTOELECTRONICS TECHNOLOGY CO., LTD., Shenzhen (CN)

(21) Appl. No.: 19/238,513

(22) Filed: Jun. 15, 2025

(30) Foreign Application Priority Data
Dec. 30, 2024 (CN) 202411986757.2

(51) Int. Cl. G09G 3/20

(52) U.S. Cl. CPC G09G 3/20; G09G 2310/027; G09G 2310/0297; G09G 2330/021

(57) ABSTRACT

The present disclosure provides a display device and a display control method. The display device includes a power supply system, a detector and a source driver IC. The power supply system is configured to provide a common voltage and a data driving voltage for the source driver IC. The detector is configured to detect whether there are multiple continuous frames of black data in display data output by the source driver IC, and send a display control signal to the source driver IC when the multiple continuous frames of the black data exist. The source driver IC is configured to short to the common voltage according to the display control signal when the display device displays a first frame of the black data, and access the data driving voltage according to the display control signal when the display device displays a last frame of the black data.

### CROSS-REFERENCE TO RELATED APPLICATION

The application claims priority to and the benefit of Chinese Patent Application No. 202411986757.2, filed on Dec. 30, 2024, the disclosure of which is incorporated herein by reference in its entirety.

### TECHNICAL FIELD

The present disclosure relates to display technologies, and in particular, to a display device and a display control method.

### BACKGROUND

With the development of the display technologies, users have higher and higher requirements for energy consumption of the display device. Reducing the energy consumption of the display device is conducive to improving product competitiveness, promoting environmental protection, prolonging service life, enhancing power efficiency, etc., and thus a display device with low power consumption has become an important development direction of the display technologies. How to reduce the energy consumption of the display device is a subject that the industry has been committed to researching.

### SUMMARY

Embodiments of the present disclosure provide a display device and a display control method. Dynamic power consumption of a source driver IC can be reduced by adding a control of a black data power down mode, and thus the energy consumption of the display device can be reduced.

An embodiment of the present disclosure provides a display device, including a power supply system, a detector and a source driver IC.

The power supply system is configured to provide a common voltage and a data driving voltage for the source driver IC.

The detector is configured to detect whether there are multiple continuous frames of black data in display data output by the source driver IC, and is configured to send a display control signal to the source driver IC when the multiple continuous frames of the black data exist.

The source driver IC is configured to short to the common voltage according to the display control signal when the display device displays a first frame of the multiple continuous frames of the black data, and is configured to access the data driving voltage according to the display control signal when the display device displays a last frame of the multiple continuous frames of the black data.

Correspondingly, an embodiment of the present disclosure provides a display control method, applied to a display device. The display device includes a power supply system, a detector and a source driver IC. The display control method includes:
detecting, by the detector, whether there are multiple continuous frames of black data in display data output by the source driver IC, and sending a display control signal to the source driver IC when the multiple continuous frames of the black data exist;
shorting, by the source driver IC, to a common voltage provided by the power supply system according to the display control signal when the display device displays a first frame of the multiple continuous frames of the black data, and accessing a data driving voltage provided by the power supply system according to the display control signal when the display device displays a last frame of the multiple continuous frames of the black data.

### BRIEF DESCRIPTION OF THE DRAWINGS

FIG. 1 is a schematic diagram of a display device according to an embodiment of the present disclosure;

FIG. 2 is a schematic diagram of at least part of content included in an image frame according to an embodiment of the present disclosure;

FIG. 3 is a schematic diagram of a line configuration according to an embodiment of the present disclosure;

FIG. 4 is a schematic diagram of meanings of instructions according to an embodiment of the present disclosure;

FIG. 5 is a schematic diagram of a source driver IC according to an embodiment of the present disclosure;

FIG. 6 is a schematic diagram of another source driver IC according to an embodiment of the present disclosure;

FIG. 7 is a flowchart of a display control method according to an embodiment of the present disclosure;

FIG. 8 is a flowchart of another display control method according to an embodiment of the present disclosure.

### DETAILED DESCRIPTION

Technical solutions in the embodiments of the present disclosure will be described below in conjunction with drawings in the embodiments of the present disclosure. The described technical solutions are merely for explaining and illustrating the ideas of the present disclosure, and should not be construed as limiting the scope of protection of the present disclosure.

In addition, “multiple” in the embodiments of the present disclosure refers to two or more. “First”, “second” and the like in the embodiments of the present disclosure are used to distinguish different technical features, and do not indicate any order, quantity, or importance.

The various embodiments provided in the present disclosure are similar, and features in different embodiments may be combined with each other.

The order of description of the following embodiments is not intended to limit the preferred order of the embodiments.

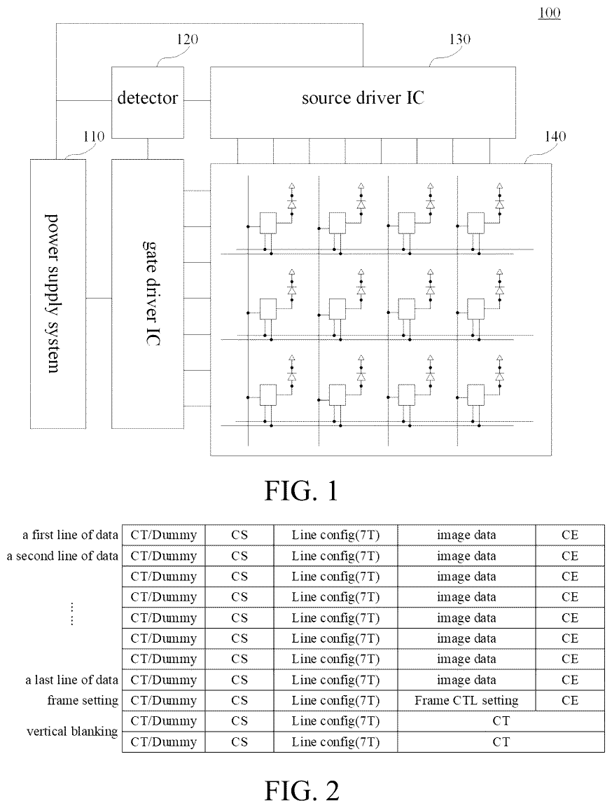

Referring to FIG. 1, FIG. 1 is a schematic diagram of a display device according to an embodiment of the present disclosure. As shown in FIG. 1, the display device 100 includes a power supply system 110, a detector 120 and a source driver IC 130.

The power supply system 110 is configured to provide a common voltage and a data driving voltage for the source driver IC 130.

The detector 120 is configured to detect whether there are multiple continuous frames of black data in display data output by the source driver IC 130, and is configured to send a display control signal to the source driver IC 130 when the multiple continuous frames of the black data exist.

The source driver IC 130 is configured to short to the common voltage provided by the power supply system 110 according to the display control signal when the display device 100 displays a first frame of the multiple continuous frames of the black data, and is configured to access the data driving voltage provided by the power supply system 110 according to the display control signal when the display device 100 displays a last frame of the multiple continuous frames of the black data.

The source driver IC 130 is also referred to as a source integrated circuit (Source IC) or a Driver IC. The source driver IC 130 includes one or more data channels for transmitting data signals, and generally, one source driver IC 130 has a plurality of the data channels, and each of the data channel may provide data for a certain number of sub-pixels. Since a number of the data channels of one source driver IC 130 is limited, one display device 100 is usually driven by a plurality of the source driver ICs 130, for example, the number of the source driver ICs 130 ranges from 4 to 24. Optionally, the number of the source driver ICs 130 is related to the lateral resolution of the display device 100 and the number of the data channels of a single source driver IC 130. For example, the number of the source driver ICs 130 is equal to a quotient between three times the lateral resolution of the display device 100 and the number of the data channels of the source driver IC 130. Exemplarily, if the resolution of the display device 100 is 3840×2160 and the lateral resolution is 3840, 11520 (3840×3) data channels are used in total, and if there are 960 data channels that can be driven by a single source driver IC 130, the display device 100 needs to be driven by using 12 source driver ICs 130. Data channel index values of a first source driver IC 130 are 1-960, data channel index values of a second source driver IC 130 are 961-1920, and data channel index values corresponding to other source driver ICs 130 are deduced by analogy. The sub-pixels driven by a single source driver IC 130 may be located in multiple rows of a display image.

The detector 120 may be a timing controller (TCON) or a system on chip (SOC). The detector 120 may detect data transmitted in the data channels of any one or more source driver ICs 130, so as to detect whether there are the multiple continuous frames of the black data, such as at least two continuous frames of the black data, in the display data output by the source driver IC 130. In the embodiment of the present disclosure, if the detector 120 detects that there are the multiple continuous frames of the black data in the display data of the source driver IC 130, the detector 120 sends the display control signal to the source driver IC 130, so that the source driver IC 130 enables or disables the black data power down (BDPD) mode according to the display control signal. When the display device 100 displays the first frame of the multiple continuous frames of the black data, the source driver IC 130 enables the black data power down mode according to the display control signal, and shorts outputs of the source driver IC 130 to the common voltage provided by the power supply system 110, so as to save the power consumption of the source driver IC 130. When the display device 100 displays the last frame of the multiple continuous frames of the black data, the source driver IC 130 releases the short circuit between the outputs of the source driver IC 130 and the common voltage, and controls the source driver IC 130 to access the data driving voltage provided by the power supply system 110, so as to restore the normal display of the display image in time. The common voltage is usually less than the data driving voltage.

The enabling or disabling of the black data power down mode may be indicated in the line configuration (Line Config). In some embodiments, the detector 120 is further configured to write a first bit value combination into a preset bit combination of a line configuration corresponding to the first frame of the multiple continuous frames of the black data, and write a second bit value combination into the preset bit combination of a line configuration corresponding to the last frame of the multiple continuous frames of the black data, thereby achieving a purpose of sending the display control signal to the source driver IC 130, when the multiple continuous frames of the black data are detected in the display data output by the source driver IC 130. The first bit value combination is different from the second bit value combination. Therefore, the source driver IC 130 is further configured to: short to the common voltage provided by the power supply system 110 when the first bit value combination is identified in the preset bit combination of a line configuration; and access the data driving voltage provided by the power supply system 110 when the second bit value combination is identified in the preset bit combination of a line configuration.

If the detector 120 detects that there are the multiple continuous frames of the black data in the display data of the source driver IC 130, the black data power down mode is enabled in the line configuration corresponding to the first frame of the black data, and the black data power down mode is disabled in the line configuration corresponding to the last frame of the black data. In the embodiments of the present disclosure, the black data power down mode is configured in the preset bit combination of the line configuration, the first preset bit value combination may be written into the preset bit combination of a line configuration when the black data power down mode is enabled, and the second preset bit value combination may be written into the preset bit combination of a line configuration when the black data power down mode is disabled. That is, in the embodiments of the present disclosure, the first bit value combination is written into the preset bit combination of the line configuration corresponding to the first frame of the black data, and the second bit value combination is written into the preset bit combination of the line configuration corresponding to the last frame of the black data. The first bit value combination is different from the second bit value combination, so as to indicate that the black data power down mode is enabled or disabled.

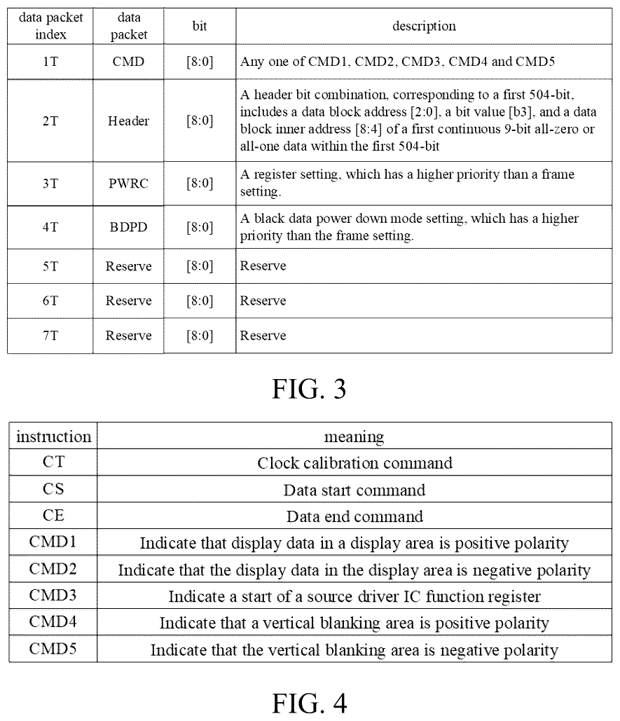

Exemplarily, FIG. 2 is a schematic diagram of at least part of content included in an image frame according to an embodiment of the present disclosure, FIG. 3 is a schematic diagram of a line configuration corresponding to each line of data in an image frame according to an embodiment of the present disclosure, and meanings of instructions in the image frame and the line configuration are shown in FIG. 4. As shown in FIG. 3, the line configuration corresponding to each line of data in the image frame includes a 1T CMD bit combination, a 1T Header bit combination, a 1T PWRC bit combination, a 1T BDPD bit combination, and a 3T Reserve bit combination. The 1T BDPD bit combination is located at the 4Tth of the line configuration, and the BDPD bit combination is the aforementioned preset bit combination, that is, the preset bit combination is located at the 4Tth of the line configuration. It should be understood that 1T in the embodiments of the present disclosure is a data packet.

A number of bits corresponding to the first bit value combination, a number of bits corresponding to the second bit value combination, and a number of bits of the preset bit combination are the same. The number of bits of the preset bit combination, a specific value of the first bit value combination, and a specific value of the second bit value combination are not limited in the embodiments of the present disclosure, and may be flexibly set with reference to requirements in actual application. For example, as shown in FIG. 4, the preset bit combination includes 9 bits. In some embodiments, the first bit value combination may be 111111111, and the second bit value combination may be 000000000; or the first bit value combination may be 111100000, and the second bit value combination may be 000000000; or the first bit value combination may be 100000000, and the second bit value combination may be 011111111. In actual application, the first bit value combination and the second bit value combination may be arbitrarily set, but the first bit value combination and the second bit value combination need to be different.

In some embodiments, the detector 120 is further configured to write the first bit value combination into a preset bit combination of a first line configuration. The first line configuration is a line configuration corresponding to a first line of data in the first frame of the multiple continuous frames of the black data. That is, in the embodiments of the present disclosure, for the multiple continuous frames of the black data, the black data power down mode is enabled in the line configuration corresponding to the first line of data in the first frame of the black data.

In some embodiments, the detector 120 is further configured to write the second bit value combination into a preset bit combination of a second line configuration. The second line configuration is a line configuration corresponding to a last line of data in the last frame of the multiple continuous frames of the black data. That is, in the embodiments of the present disclosure, for the multiple continuous frames of the black data, the black data power down mode is disabled in the line configuration corresponding to the last line of data in the last frame of the black data.

In some embodiments, the detector 120 is further configured to write a third bit value combination into a preset bit combination of a third line configuration. Among the multiple continuous frames of the black data, a third data corresponding to the third line configuration is located between a second data corresponding to the second line configuration and a first data corresponding to the first line configuration. That is, the black data corresponding to the third line configuration is located between the black data corresponding to the second line configuration and the black data corresponding to the first line configuration. In the embodiments of the present disclosure, for the multiple continuous frames of the black data, except the line configuration corresponding to the first line of data in the first frame of the black data and the line configuration corresponding to the last line of data in the last frame of the black data, the third bit value combination may be written into preset bit combinations of other line configurations to indicate that the black data power down mode remains enabled. Since the third bit value combination indicates that the black data power down mode is still enabled, the third bit value combination should be different from the second bit value combination. Optionally, the third bit value combination is the same as the first bit value combination; or the third bit value combination is different from the first bit value combination. For example, the first bit value combination may be 111111111, the second bit value combination may be 000000000, and the third bit value combination may be 11110000; or the first bit value combination and the third bit value combination may be 111111111, and the second bit value combination may be 000000000.

Exemplarily, the detector 120 detects that there are N continuous frames of the black data in all data channels of a certain source driver IC 130, where N is a positive integer; the detector 120 writes the first bit value combination into the preset bit combination of a line configuration corresponding to a first line of data in a first frame of the N frames of the black data to indicate that the black data power down mode is enabled; the detector 120 writes the second bit value combination into the preset bit combination of a line configuration corresponding to a last line of data in a last frame of the N frames of the black data to indicate that the black data power down mode is disabled; and the detector 120 writes the third bit value combination into preset bit combinations of other line configurations corresponding to the N frames of the black data to indicate that the black data power down mode maintains enabled. The third bit value combination is different from the second bit value combination, and the third bit value combination is the same as or different from the first bit value combination.

The source driver IC 130 continuously identifies preset bit combinations of line configurations. If the first bit value combination is identified in the preset bit combination of a line configuration, it is confirmed that the black data power down mode is enabled, and the source driver IC 130 shorts the outputs of the source driver IC 130 to the common voltage provided by the power supply system 110. If the second bit value combination is identified in the preset bit combination of a line configuration, it is confirmed that the black data power down mode is disabled, and the source driver IC 130 releases the short circuit between the outputs of the source driver IC 130 and the common voltage, and controls the source driver IC 130 to access the data driving voltage provided by the power supply system 110. If the third bit value combination is identified in the preset bit combination of a line configuration, it is confirmed that the black data power down mode maintains enabled, and the source driver IC 130 maintains the short circuit between the outputs of the source driver IC 130 and the common voltage.

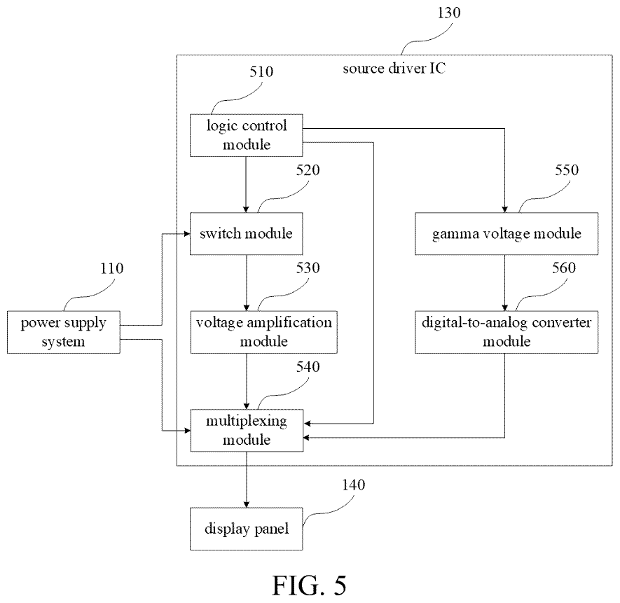

In some embodiments, as shown in FIG. 1, the display device 100 further includes a display panel 140, and as shown in FIG. 5, the source driver IC 130 includes a logic control module 510, a switch module 520, a voltage amplification module 530 and a multiplexing module 540. The switch module 530 is connected with the logic control module 510, the power supply system 110 and the voltage amplification module 530, the voltage amplification module 530 is further connected with the multiplexing module 540, and the multiplexing module 540 is further connected with the power supply system 110. For example, as shown in FIG. 5, the switch module 520 includes a control electrode connected with the logic control module 510, a first electrode connected with the data driving voltage VAA provided by the power supply system 110, and a second electrode connected with a first terminal of the voltage amplification module 530; the voltage amplification module 530 includes the first terminal connected with the second electrode of the switch module 520, a second terminal connected with an input voltage VIN, and a third terminal connected with the multiplexing module 540; and the multiplexing module 540 includes a first input terminal connected with the third terminal of the voltage amplification module 530, a second input terminal connected with the common voltage VCOM provided by the power supply system 110, and an output terminal connected with the display panel 140.

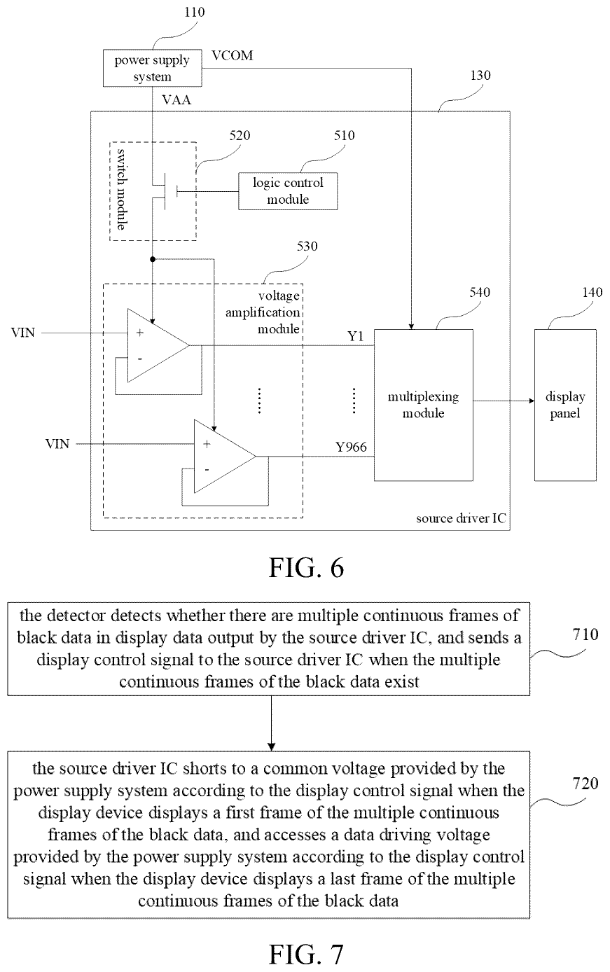

Based on this, the logic control module 510 is configured to: control the switch module 520 to be turned off and control the multiplexing module 540 to short to the common voltage VCOM provided by the power supply system 110 when the first bit value combination is identified in the preset bit combination of a line configuration; control the switch module 520 to be turned on so that the voltage amplification module 530 can access the data driving voltage VAA provided by the power supply system 110 when the second bit value combination is identified in the preset bit combination of a line configuration; and control the switch module 520 to maintain being turned off and control the multiplexing module 540 to maintain shorting to the common voltage VCOM when the third bit value combination is identified in the preset bit combination of a line configuration. As shown in FIG. 6, the switch module 520 may include at least one transistor, such as a P-type thin film transistor or an N-type thin film transistor. When the switch module 520 is turned on, the data driving voltage VAA may flow into the voltage amplification module 530, and the multiplexing module 540 releases the short circuit with the common voltage VCOM; when the switch module 520 is turned off, the data driving voltage VAA cannot flow into the voltage amplification module 530, and the multiplexing module 540 shorts to the common voltage VCOM. In addition, as shown in FIG. 6, the voltage amplification module 530 may include multiple amplifiers, and each of the amplifiers is connected with the multiplexing module 540.

In some embodiments, as shown in FIG. 5, the source driver IC 130 further includes a gamma voltage module 550 and a digital-to-analog converter (DAC) module 560. The gamma voltage module 550 is connected with the logic control module 510 and the digital-to-analog converter module 560, and the digital-to-analog converter module 560 is further connected with the multiplexing module 540. For example, as shown in FIG. 5, the gamma voltage module 550 includes a first terminal connected with the logic control module 510 and a second terminal connected with a first terminal of the digital-to-analog converter module 560; and the digital-to-analog converter module 560 includes the first terminal connected with the second terminal of the gamma voltage module 550 and a second terminal connected with the multiplexing module 540.

Based on this, the logic control module 510 is further configured to: turn off the gamma voltage module 550 when the first bit value combination is identified in the preset bit combination of a line configuration; turn on the gamma voltage module 550 when the second bit value combination is identified in the preset bit combination of a line configuration; and maintain the gamma voltage module 550 being turned off when the third bit value combination is identified in the preset bit combination of a line configuration. The digital-to-analog converter module 560 converts a digital signal into an analog signal, and the gamma voltage module 550 provides a reference voltage for the digital-to-analog converter module 560.

In conclusion, in the embodiments of the present disclosure, a black data power down mode is added. If it is detected that there are continuous black data in display data output by a source driver IC, a display control signal is sent to the source driver IC, so as to indicate to the source driver IC that the black data power down mode is enabled when a first frame of the black data is displayed, and indicate to the source driver IC that the black data power down mode is disabled when a last frame of the black data is displayed. According to the display control signal, the source driver IC shorts to a common voltage provided by a power supply system when the display device displays the first frame of the black data, so as to save the power consumption of the source driver IC. In addition, according to the display control signal, the source driver IC releases the short circuit with the common voltage when the display device displays the last frame of the black data, and accesses a data driving voltage provided by the power supply system, so as to restore a normal display of display images. In the embodiments of the present disclosure, the dynamic power consumption of the source driver IC can be reduced by adding the control of the black data power down mode, and thus the energy consumption of the display device can be reduced. Moreover, the embodiments of the present disclosure can be implemented based on an existing display device, without adding a new component to the display device, and has high compatibility with the existing display device.

In the embodiments of the present disclosure, the black data power down mode is configured in a preset bit combination of a line configuration. If it is detected that there is continuous black data in all channels of the source driving IC, a first bit value combination is written into the preset bit combination of a line configuration corresponding to a first frame of the black data, for example, the first bit value combination is written into the preset bit combination of a line configuration corresponding to a first line of data in the first frame of the black data, so as to indicate to the source driving IC that the black data power down mode is enabled; and a second bit value combination is written into the preset bit combination of a line configuration corresponding to a last frame of the black data, for example, the second bit value combination is written into the preset bit combination of a line configuration corresponding to a last line of data in the last frame of the black data, so as to indicate to the source driving IC that the black data power down mode is disabled. Based on an identification of the first bit value combination, the source driver IC shorts to the common voltage provided by the power supply system to save the power consumption of the source driver IC; and based on an identification of the second bit value combination, the source driver IC releases the short circuit with the common voltage and accesses the data driving voltage provided by the power supply system to restore the normal display of the display images.

Referring to FIG. 7, FIG. 7 is a flowchart of a display control method according to an embodiment of the present disclosure. The display control method may be applied to the aforementioned display device. The display device includes a power supply system, a detector and a source driver IC. As shown in FIG. 7, the display control method may include the following steps.
Step 710, the detector detects whether there are multiple continuous frames of black data in display data output by the source driver IC, and sends a display control signal to the source driver IC when the multiple continuous frames of the black data exist.
Step 720, the source driver IC shorts to a common voltage provided by the power supply system according to the display control signal when the display device displays a first frame of the multiple continuous frames of the black data, and accesses a data driving voltage provided by the power supply system according to the display control signal when the display device displays a last frame of the multiple continuous frames of the black data.

In some embodiments, the aforementioned step 710 includes: the detector writing a first bit value combination into a preset bit combination of a line configuration corresponding to the first frame of the multiple continuous frames of the black data, and writing a second bit value combination into the preset bit combination of a line configuration corresponding to the last frame of the multiple continuous frames of the black data, when the multiple continuous frames of the black data are detected in the display data output by the source driver IC. The first bit value combination is different from the second bit value combination.

In some embodiments, the aforementioned step 720 includes: the source driver IC shorting to the common voltage provided by the power supply system when the first bit value combination is identified in the preset bit combination of a line configuration; and the source driver IC accessing the data driving voltage provided by the power supply system when the second bit value combination is identified in the preset bit combination of a line configuration.

In some embodiments, the aforementioned step 710 includes: the detector writing the first bit value combination into a preset bit combination of a first line configuration. The first line configuration is a line configuration corresponding to a first line of data in the first frame of the multiple continuous frames of the black data.

In some embodiments, the aforementioned step 710 includes: the detector writing the second bit value combination into a preset bit combination of a second line configuration. The second line configuration is a line configuration corresponding to a last line of data in the last frame of the multiple continuous frames of the black data.

In some embodiments, the aforementioned display control method further includes: the detector writing a third bit value combination into a preset bit combination of a third line configuration. Among the multiple continuous frames of the black data, a third data corresponding to the third line configuration is located between a second data corresponding to the second line configuration and a first data corresponding to the first line configuration. The third bit value combination is different from the second bit value combination; and the third bit value combination is the same as or different from the first bit value combination.

In some embodiments, the aforementioned display control method further includes: the source driver IC maintaining shorting to the common voltage when the third bit value combination is identified in the preset bit combination of a line configuration by the source driver IC.

In some embodiments, the source driver IC includes a logic control module, a switch module, a voltage amplification module and a multiplexing module. The switch module is connected with the logic control module, the power supply system and the voltage amplification module, the voltage amplification module is further connected with the multiplexing module, and the multiplexing module is further connected with the power supply system. The aforementioned step 720 includes: the logic control module controlling the switch module to be turned off and controlling the multiplexing module to short to the common voltage when the first bit value combination is identified in the preset bit combination of a line configuration by the logic control module; and the logic control module controlling the switch module to be turned on so that the voltage amplification module can access the data driving voltage when the second bit value combination is identified in the preset bit combination of a line configuration by the logic control module.

In some embodiments, the source driver IC further includes a gamma voltage module, and the gamma voltage module is connected with the logic control module. The display control method further includes: the logic control module turning off the gamma voltage module when the first bit value combination is identified in the preset bit combination of a line configuration by the logic control module; and the logic control module turning on the gamma voltage module when the second bit value combination is identified in the preset bit combination of a line configuration by the logic control module.

In some embodiments, the source driver IC further includes a digital-to-analog converter module, and the digital-to-analog converter module is connected with the gamma voltage module and the multiplexing module. The display control method further includes: the gamma voltage module providing a reference voltage for the digital-to-analog converter module.

In conclusion, in the embodiments of the present disclosure, a black data power down mode is added. If it is detected that there are continuous black data in display data output by a source driver IC, a display control signal is sent to the source driver IC, so as to indicate to the source driver IC that the black data power down mode is enabled when a first frame of the black data is displayed, and indicate to the source driver IC that the black data power down mode is disabled when a last frame of the black data is displayed. According to the display control signal, the source driver IC shorts to a common voltage provided by a power supply system when the display device displays the first frame of the black data, so as to save the power consumption of the source driver IC. In addition, according to the display control signal, the source driver IC releases the short circuit with the common voltage when the display device displays the last frame of the black data, and accesses a data driving voltage provided by the power supply system, so as to restore a normal display of display images. In the embodiments of the present disclosure, the dynamic power consumption of the source driver IC can be reduced by adding the control of the black data power down mode, and thus the energy consumption of the display device can be reduced. Moreover, the embodiments of the present disclosure can be implemented based on an existing display device, without adding a new component to the display device, and has high compatibility with the existing display device.

In the embodiments of the present disclosure, the black data power down mode is configured in a preset bit combination of a line configuration. If it is detected that there is continuous black data in all channels of the source driving IC, a first bit value combination is written into the preset bit combination of a line configuration corresponding to a first frame of the black data, for example, the first bit value combination is written into the preset bit combination of a line configuration corresponding to a first line of data in the first frame of the black data, so as to indicate to the source driving IC that the black data power down mode is enabled; and a second bit value combination is written into the preset bit combination of a line configuration corresponding to a last frame of the black data, for example, the second bit value combination is written into the preset bit combination of a line configuration corresponding to a last line of data in the last frame of the black data, so as to indicate to the source driving IC that the black data power down mode is disabled. Based on an identification of the first bit value combination, the source driver IC shorts to the common voltage provided by the power supply system to save the power consumption of the source driver IC; and based on an identification of the second bit value combination, the source driver IC releases the short circuit with the common voltage and accesses the data driving voltage provided by the power supply system to restore the normal display of the display images.

The display control method provided in an embodiment of the present disclosure is described below in an example.

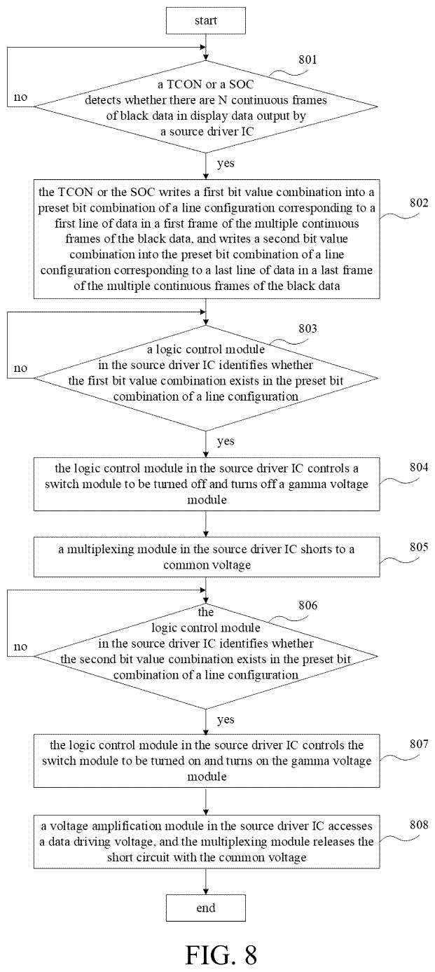

Referring to FIG. 8, FIG. 8 is a flowchart of another display control method according to an embodiment of the present disclosure. As shown in FIG. 8, the display control method may include the following steps 801 to 808.
Step 801, a TCON or a SOC detects whether there are N continuous frames of black data in display data output by a source driver IC. N is a positive integer. If the N continuous frames of the black data are detected, go to step 802; otherwise, continue with step 801.
Step 802, the TCON or the SOC writes a first bit value combination into a preset bit combination of a line configuration corresponding to a first line of data in a first frame of the multiple continuous frames of the black data, and writes a second bit value combination into the preset bit combination of a line configuration corresponding to a last line of data in a last frame of the multiple continuous frames of the black data.
Step 803, a logic control module in the source driver IC identifies whether the first bit value combination exists in the preset bit combination of a line configuration. If yes, go to step 804; otherwise, continue with step 803.
Step 804, the logic control module in the source driver IC controls a switch module to be turned off and turns off a gamma voltage module.
Step 805, a multiplexing module in the source driver IC shorts to a common voltage.
Step 806, the logic control module in the source driver IC identifies whether the second bit value combination exists in the preset bit combination of a line configuration. If yes, go to step 807; otherwise, continue with step 806.
Step 807, the logic control module in the source driver IC controls the switch module to be turned on and turns on the gamma voltage module.
Step 808, a voltage amplification module in the source driver IC accesses a data driving voltage, and the multiplexing module releases the short circuit with the common voltage.

It should be understood that the aforementioned display control method is a method embodiment corresponding to the aforementioned display device, and the detailed description of each step and the beneficial effects thereof in the display control method may refer to the embodiments of the aforementioned display device, which will not be repeated herein.

In the aforementioned embodiments, the description of each embodiment focuses on different perspectives, and contents not described in detail in a certain embodiment may be referred to the related description in other embodiments.

The present disclosure has been described in detail with reference to a display device and a display control method provided in the embodiments of the present disclosure. Specific examples are used herein to illustrate the principles and embodiments of the present disclosure. The description of the above embodiments is merely intended to help understand the technical solutions and the core idea of the present disclosure. At the same time, those skilled in the art may make modifications to the specific implementation modes and applying ranges based on concepts disclosed herein. In summary, the content of the description should not be construed as limiting the scope of the present disclosure.

What is claimed is:

1. A display device, comprising a power supply system, a detector and a source driver IC;
wherein the power supply system is configured to provide a common voltage and a data driving voltage for the source driver IC;
wherein the detector is configured to detect whether there are multiple continuous frames of black data in display data output by the source driver IC, and is configured to send a display control signal to the source driver IC when the multiple continuous frames of the black data exist;
wherein the source driver IC is configured to short to the common voltage according to the display control signal when the display device displays a first frame of the multiple continuous frames of the black data, and is configured to access the data driving voltage according to the display control signal when the display device displays a last frame of the multiple continuous frames of the black data.

2. The display device according to claim 1,
wherein the detector is configured to: write a first bit value combination into a preset bit combination of a line configuration corresponding to the first frame of the multiple continuous frames of the black data, and write a second bit value combination into the preset bit combination of a line configuration corresponding to the last frame of the multiple continuous frames of the black data, when the multiple continuous frames of the black data are detected in the display data output by the source driver IC; wherein the first bit value combination is different from the second bit value combination;
wherein the source driver IC is configured to: short to the common voltage when the first bit value combination is identified in the preset bit combination of a line configuration; and access the data driving voltage when the second bit value combination is identified in the preset bit combination of a line configuration.

3. The display device according to claim 2, wherein the detector is further configured to:
write the first bit value combination into a preset bit combination of a first line configuration; wherein the first line configuration is a line configuration corresponding to a first line of data in the first frame of the multiple continuous frames of the black data.

4. The display device according to claim 3, wherein the detector is further configured to:
write the second bit value combination into a preset bit combination of a second line configuration; wherein the second line configuration is a line configuration corresponding to a last line of data in the last frame of the multiple continuous frames of the black data.

5. The display device according to claim 4, wherein the detector is further configured to:
write a third bit value combination into a preset bit combination of a third line configuration; wherein among the multiple continuous frames of the black data, a third data corresponding to the third line configuration is located between a second data corresponding to the second line configuration and a first data corresponding to the first line configuration; the third bit value combination is different from the second bit value combination; and the third bit value combination is the same as or different from the first bit value combination.

6. The display device according to claim 5, wherein the source driver IC is further configured to:
maintain shorting to the common voltage when the third bit value combination is identified in the preset bit combination of a line configuration.

7. The display device according to claim 2, wherein the source driver IC comprises a logic control module, a switch module, a voltage amplification module and a multiplexing module; the switch module is connected with the logic control module, the power supply system and the voltage amplification module, the voltage amplification module is further connected with the multiplexing module, and the multiplexing module is further connected with the power supply system; and
the logic control module is configured to: control the switch module to be turned off and control the multiplexing module to short to the common voltage when the first bit value combination is identified in the preset bit combination of a line configuration;
and control the switch module to be turned on so that the voltage amplification module accesses the data driving voltage when the second bit value combination is identified in the preset bit combination of a line configuration.

8. The display device according to claim 7, wherein the display device further comprises a display panel;
the switch module comprises a control electrode connected with the logic control module, a first electrode connected with the data driving voltage provided by the power supply system, and a second electrode connected with a first terminal of the voltage amplification module;
the voltage amplification module comprises the first terminal connected with the second electrode of the switch module, a second terminal connected with an input voltage, and a third terminal connected with the multiplexing module; and
the multiplexing module comprises a first input terminal connected with the third terminal of the voltage amplification module, a second input terminal connected with the common voltage provided by the power supply system, and an output terminal connected with the display panel.

9. The display device according to claim 7, wherein the source driver IC further comprises a gamma voltage module, and the gamma voltage module is connected with the logic control module; and
the logic control module is further configured to: turn off the gamma voltage module when the first bit value combination is identified in the preset bit combination of a line configuration; and turn on the gamma voltage module when the second bit value combination is identified in the preset bit combination of a line configuration.

10. The display device according to claim 9, wherein the source driver IC further comprises a digital-to-analog converter module, and the digital-to-analog converter module is connected with the gamma voltage module and the multiplexing module; and
the gamma voltage module is configured to: provide a reference voltage for the digital-to-analog converter module.

11. The display device according to claim 10, wherein the gamma voltage module comprises a first terminal connected with the logic control module and a second terminal connected with a first terminal of the digital-to-analog converter module; and the digital-to-analog converter module comprises the first terminal connected with the second terminal of the gamma voltage module and a second terminal connected with the multiplexing module.

12. A display control method, applied to a display device, wherein the display device comprises a power supply system, a detector and a source driver IC; and the display control method comprises:
detecting, by the detector, whether there are multiple continuous frames of black data in display data output by the source driver IC, and sending a display control signal to the source driver IC when the multiple continuous frames of the black data exist;
shorting, by the source driver IC, to a common voltage provided by the power supply system according to the display control signal when the display device displays a first frame of the multiple continuous frames of the black data, and accessing a data driving voltage provided by the power supply system according to the display control signal when the display device displays a last frame of the multiple continuous frames of the black data.

13. The display control method according to claim 12,
wherein detecting, by the detector, whether there are multiple continuous frames of black data in display data output by the source driver IC, and sending a display control signal to the source driver IC when the multiple continuous frames of the black data exist comprises:
writing, by the detector, a first bit value combination into a preset bit combination of a line configuration corresponding to the first frame of the multiple continuous frames of the black data, and writing a second bit value combination into the preset bit combination of a line configuration corresponding to the last frame of the multiple continuous frames of the black data, when the multiple continuous frames of the black data are detected in the display data output by the source driver IC; wherein the first bit value combination is different from the second bit value combination;
wherein shorting, by the source driver IC, to a common voltage provided by the power supply system according to the display control signal when the display device displays a first frame of the multiple continuous frames of the black data, and accessing a data driving voltage provided by the power supply system according to the display control signal when the display device displays a last frame of the multiple continuous frames of the black data comprises:
shorting, by the source driver IC, to the common voltage provided by the power supply system when the first bit value combination is identified in the preset bit combination of a line configuration; and accessing, by the source driver IC, the data driving voltage provided by the power supply system when the second bit value combination is identified in the preset bit combination of a line configuration.

14. The display control method according to claim 13, wherein writing, by the detector, a first bit value combination into the preset bit combination of a line configuration corresponding to the first frame of the multiple continuous frames of the black data comprises:
writing, by the detector, the first bit value combination into a preset bit combination of a first line configuration; wherein the first line configuration is a line configuration corresponding to a first line of data in the first frame of the multiple continuous frames of the black data.

15. The display control method according to claim 14, wherein writing, by the detector, a second bit value combination into the preset bit combination of a line configuration corresponding to the last frame of the multiple continuous frames of the black data comprises:
writing, by the detector, the second bit value combination into a preset bit combination of a second line configuration; wherein the second line configuration is a line configuration corresponding to a last line of data in the last frame of the multiple continuous frames of the black data.

16. The display control method according to claim 15, wherein the display control method further comprises:
writing, by the detector, a third bit value combination into a preset bit combination of a third line configuration; wherein among the multiple continuous frames of the black data, a third data corresponding to the third line configuration is located between a second data corresponding to the second line configuration and a first data corresponding to the first line configuration; the third bit value combination is different from the second bit value combination; and the third bit value combination is the same as or different from the first bit value combination.

17. The display control method according to claim 16, wherein the display control method further comprises:
maintaining, by the source driver IC, shorting to the common voltage when the third bit value combination is identified in the preset bit combination of a line configuration.

18. The display control method according to claim 13, wherein the source driver IC comprises a logic control module, a switch module, a voltage amplification module and a multiplexing module; the switch module is connected with the logic control module, the power supply system and the voltage amplification module, the voltage amplification module is further connected with the multiplexing module, and the multiplexing module is further connected with the power supply system; and
wherein shorting, by the source driver IC, to the common voltage provided by the power supply system when the first bit value combination is identified in the preset bit combination of a line configuration; and accessing, by the source driver IC, the data driving voltage provided by the power supply system when the second bit value combination is identified in the preset bit combination of a line configuration comprises:
controlling, by the logic control module, the switch module to be turned off and controlling the multiplexing module to short to the common voltage when the first bit value combination is identified in the preset bit combination of a line configuration; and
controlling, by the logic control module, the switch module to be turned on so that the voltage amplification module accesses the data driving voltage when the second bit value combination is identified in the preset bit combination of a line configuration.

19. The display control method according to claim 18, wherein the source driver IC further comprises a gamma voltage module, and the gamma voltage module is connected with the logic control module; and the display control method further comprises:
turning off, by the logic control module, the gamma voltage module when the first bit value combination is identified in the preset bit combination of a line configuration; and
turning on, by the logic control module, the gamma voltage module when the second bit value combination is identified in the preset bit combination of a line configuration.

20. The display control method according to claim 19, wherein the source driver IC further comprises a digital-to-analog converter module, and the digital-to-analog converter module is connected with the gamma voltage module and the multiplexing module; and the display control method further comprises:
providing, by the gamma voltage module, a reference voltage for the digital-to-analog converter module.
